(19) United States
(12) Patent Application Publication
(10) Pub. No.: US 2026/0036241 A1
(43) Pub. Date: Feb. 5, 2026

(54) DEVICES AND METHODS FOR REPAIRING SUBSURFACE FAULTS THROUGH A SINGLE EXCAVATION POINT

(71) Applicants: SCOTT ANTHONY CURTIS, Snohomish, WA (US); Richard Randolph Bentz, Lake Stevens, WA (US); Spencer Lee Chynoweth, Thorp, WA (US)

(72) Inventors: SCOTT ANTHONY CURTIS, Snohomish, WA (US); Richard Randolph Bentz, Lake Stevens, WA (US); Spencer Lee Chynoweth, Thorp, WA (US)

(21) Appl. No.: 18/792,260

(22) Filed: Aug. 1, 2024

(51) Int. Cl. F16L 55/18

(52) U.S. Cl. CPC F16L 55/18

(57) ABSTRACT

The present disclosure relates to systems, techniques, and methods for repairing subsurface failures such as utility failures such as a pipe that is broken, including vertically or horizontally offset breaks, holes, cracks, leaks or erosion. In some configurations, the present disclosure relates to systems including a navigable and/or flexible guide rod or shaft configured to retain an imparted shape that guides a repair tool, such as a patch delivery tool or packer, past obstructions such as defects listed above or other obstructions within the pipe such as blockages. The guidance rod also helps the repair tool to be delivered through angle changes and lateral connections. In various configurations the function of the guidance rod allows the repair tool to follow the guidance rod and deliver point repairs such as CIPP (cured in place pipe) patches to locations existing tools are unable to reach through a single access point.

### SUMMARY

In various embodiments the present disclosure relates to techniques and methods for repairing subsurface faults, such as breaks in pipes. In some embodiments, the present disclosure relates to a system for pipe repair comprising: a head member configured to be partially housed within an expandable body member; a retaining member or adhesive configured to be partially housed within the expandable body member opposite the head member; and a flexible guide rod passage disposed within the body member. In some embodiments, the head member comprises a flexible guide rod interface including an opening disposed on a portion of the head member external to the expandable body member. In the same or different embodiment, the opening extends through the head member to provide access for a flexible guide rod or shaft to the interior of the body member. In some configurations, the head member includes a retaining section and a clamp section. In the same or different configuration, the diameter of the clamp section is less than the diameter of the retaining section. In some configurations the head section may be adhered or clamped to the expandable body member, or to another member affixed thereto.

Likewise, in some embodiments the head member is configured to be removably coupled to a closing portion housed within the expandable body member. In still further configurations, the closing portion has a substantially cylindrical portion and a substantially frustoconical portion. In some of those embodiments, the closing portion has a threaded interface disposed on the substantially cylindrical portion for coupling to the head member. For example, in some configurations the threaded interface of the closing member includes a flexible guide rod access channel traversing through the closing portion. In the same or different embodiments, the retaining member has a first channel configured to receive a flow of air directed to an internal portion of the expandable body member. In some of the embodiments discussed herein, the flexible guide rod channel is communicably coupled with the head member through the guide rod interface disposed through the head member; the guide rod channel is communicably coupled with the closing member through the head member through a threaded flexible guide rod interface disposed on the closing member; the flexible guide rod channel is communicably coupled with a retaining member through a threaded interface disposed on a portion of the retaining member housed within the expandable body member; and the flexible guide rod channel provides an exit point to exit the device through the rear of the retaining member.

The present disclosure also relates to a head for a pipe packer repair tool configured to interface with a flexible guide rod system. Some embodiments of this disclosure are described such as the head having a first portion configured to extend from the front of a pipe repair system and a second portion configured to interface with the interior of a pipe repair system; the head having an access point for a flexible guide rod to be routed into the interior of a pipe packer repair tool; the access point on the head being communicably coupled with an internal channel disposed through the head and configured to receive a guide flexible shaft; the internal channel within the head being configured to be removably coupled with a closing portion; the closing portion having a substantially cylindrical portion and a substantially frustoconical portion; the closing portion having an interface configured to be removably coupled to the internal channel within the head; the interface of the closing portion being communicably coupled with an internal channel disposed through the closing portion and configured to receive a guide rod; the internal channel of the closing portion in communication with a guide rod channel disposed within the pipe packer repair tool configured to receive a guide rod; the guide channel configured to be removably coupled to an exit interface member through an interface and to extend from the rear of the pipe packer repair tool.

In some exemplary configurations, the portion of the head configured to extend from the front of a pipe repair system has a substantially frustoconical shape. In some of those configurations, the access point is disposed at the leading edge of the frustrum. In some configurations, the head is made from a rubber, plastic, metallic, or alloy material. Likewise, variously the internal channel within the head is configured to be removably coupled through a threaded interface of a closing portion. In some embodiments the threaded interface is disposed on the substantially cylindrical portion positioned adjacent to the head member. In some of those embodiments, the interface is a threaded interface comprising a threaded extension disposed on the closing member configured to interface with a threaded receiving member disposed on the second portion of the head member.

In still further configurations, the present disclosure relates to a method for repairing a complex subsurface fault through a single excavation site, the method comprising the steps of: Accessing opening to the existing pipe, which in some configurations may include removing existing cleanout access lid, or excavating a single access point; determining the location and nature of the subsurface fault through the single access point; manipulating a substantially rigid guide rod, a substantially rigid but still manipulatable guide rod, and/or a flexible rod or shaft for insertion into the single access point.

In various configurations the manipulations are based on the determined location and nature of the subsurface fault; inserting the guide rod through the single access point and navigating past the location of the subsurface fault; threading a pipe packer repair tool onto the guide rod and navigating the repair tool to the location of the subsurface fault; applying a patch at the location of the subsurface fault; and removing the pipe packer repair tool and flexible guide rod from the single excavation point. Some embodiments of that method involve determining the nature of the subsurface fault such as determining the fault is a defect such as utility failures including pipe that is broken, vertically or horizontally offset, holes, cracks, leaks, or erosion.

In some embodiments the manipulations include attaching a guidance object such as attaching a spherical or frustoconical or angular other shaped object and or bending the tip of the guidance rod to navigate past defects and to traverse past an offset or break; and in some configurations navigating the repair tool to the location of the subsurface fault comprises pushing the pipe packer repair tool forward along the guide rod such that the pipe packer repair tool traverses defects including vertically or horizontally offset breaks and even missing sections of pipe. The guide rod guides the packer through changes of angle, lateral connections and many other defects, contours, obstacles, blockages, joints, or passageways.

### BRIEF DESCRIPTION OF DRAWINGS

Various embodiments are depicted in the accompanying drawings for illustrative purposes and should in no way be interpreted as limiting the scope of the embodiments. Various features of different disclosed embodiments can be combined to form additional embodiments, which are part of this disclosure.

The following drawings are presented for illustrative purposes only and may not be drawn to scale.

FIG. 1A schematically illustrates an orthographic X-ray perspective of an embodiment of a subsurface failure repair tool prepared in accordance with the present disclosure.

FIG. 1B schematically illustrates cross sectional view of an embodiment of a subsurface failure repair tool prepared in accordance with the present disclosure.

FIG. 1C schematically illustrates cross sectional view of an embodiment of a subsurface failure repair tool prepared in accordance with the present disclosure.

FIGS. 2A-C schematically illustrates a method for repairing a subsurface failure using techniques, processes, and devices prepared according to the present disclosure.

### DETAILED DESCRIPTION INCLUDING PREFERRED EMBODIMENT

In the field of pipe repair, various methods have been employed to address the challenges of maintaining and restoring the integrity of piping systems. Despite the advancements in these methods, there remain significant limitations that impede their effectiveness and efficiency.

### Push Packers are Limited by Directional Control

Push packers, a common method in pipe repair, are designed to be pushed through a pipe to the repair site. While they are relatively simple in design and operation, this simplicity comes at a cost. The primary limitation of push packers is their lack of directional finesse. They can only be pushed forward along the pipe, offering no control or guidance. Without guidance, the nose or front of the packer gets stopped when it contacts defects like holes, missing sections of pipe or offset sections of pipe. Push packers are also very difficult if not impossible to push past angle changes and lateral fittings such as wye fittings. Likewise, push packers are almost impossible to navigate past obstacles within pipes such as blockages or other obstacles lodged within the pipe. Without a guidance rod it is challenging to position the repair tool, such as a packer at the specific site of the damage, especially in complex piping networks with bends and junctions. Consequently, push packers are not ideal for precision repair tasks where specific targeting is required through a single excavation point.

### Push-Pull Packers Require Multiple Access Points

Another method, the push-pull packer system, attempts to address the limitations of push packers by allowing for both pushing and pulling actions. However, this method introduces a new set of challenges. Push-pull packers require access to multiple points along the pipe, which is not always feasible, especially in urban or built-up areas. The need for multiple access points often necessitates excavation at various locations, leading to increased disruption, higher costs, and longer repair times. This requirement severely limits the applicability of push-pull packers in situations where excavation is impractical or undesirable. Push-pull packers only have forward and backwards navigability. In many instances, pushing or pulling can pull the packer into a pipe defect. In various embodiments of the presently disclosed systems and methods, a guidance rod guides the packer over, past, or through defects.

### Pass-Through Packers Exhibit Size Constraints and Excavation Issues

Pass through packers are designed to allow sewage and water to pass-through a large opening in the center of the packer. This opening must be large enough to not get clogged by sewage, wipes or other debris inside sewer lines. Pass through packers are designed for large diameter such as city mainline. Pass through packer generally do not work well with typical 3 inch to 6 inch pipes that are standard in most private sewer lines. There is not enough room for the packer and a pass through passageway.

These packers, designed to pass through an entire section of pipe, are hindered by their size and the necessity for large-scale excavation. These packers are often too big for many applications, particularly in environments where pipe size is constrained. or where it is impractical to excavate large areas. The size and excavation requirements of pass-through packers make them unsuitable for use in a variety of setting such as dense urban environments, historical sites, environmentally sensitive areas, and importantly, unsuitable for use in many home environments as well. Furthermore, the extensive excavation required can lead to significant environmental impact and disruption to surrounding areas, landscaping, and structure.

### Overview

The present disclosure pertains to a pipe repair system which is aimed at overcoming the limitations of existing methodologies. Traditional techniques, which include push packers, push-pull packers, and pass-through packers, suffer from several shortcomings, such as: the need for multiple access points, a reduction in size constraints, and an inability to navigate to the area that needs repair. These deficiencies can be caused by the lack of guidance and results in inability deliver the packer and patch to area in the pipe that needs repair.

There is a significant demand for a pipe repair method that combines precision, ease of use, and minimal disruption. Such a system should be able to be directed to a problem area with finesse and accuracy, without the need for major excavation or multiple access points. Addressing these challenges is essential for advancing the field of pipe repair, particularly in complex and sensitive environments where traditional methods fall short.

The present disclosure addresses these limitations and provides an innovative solution for pipe repair. Various systems and methods are described below to illustrate various examples that may achieve one or more desired improvements. It is not necessary that any one embodiment exhibit all or any of the aforementioned improvements. Furthermore, it is contemplated that various aspects of the different systems and methods disclosed herein can be combined in various combinations to yield alternate or additional benefits.

In some embodiments, the present disclosure relates to improved systems and devices for performing a variety of remediations with respect to subsurface failures.

In various embodiments the system may include a guidable packer tip configured to interface with a guide rod system. In some embodiments, the guidable packer tip can be configured for use with a variety of packers. Likewise, in some embodiments, the guidable packer tip may be part of a larger subsurface repair kit including a guidable tip coupled with a guidable packer configured for use with a guidance system.

In some configurations, the present disclosure relates to techniques and methods for remediating subsurface faults. For example, implementations of the present disclosure relate to techniques and methods for remediating complex subsurface faults such as pipe that is broken, vertically or horizontally offset, holes, cracks, leaks through an existing access point also known as a cleanout or a single minimally invasive excavation point, such as an access hole having dimensions of about 12 inches to about 74 inches. In other configurations, the access hole may have larger dimensions such as about 74 inches to 296 inches. In other configurations, the access hole may be larger where required.

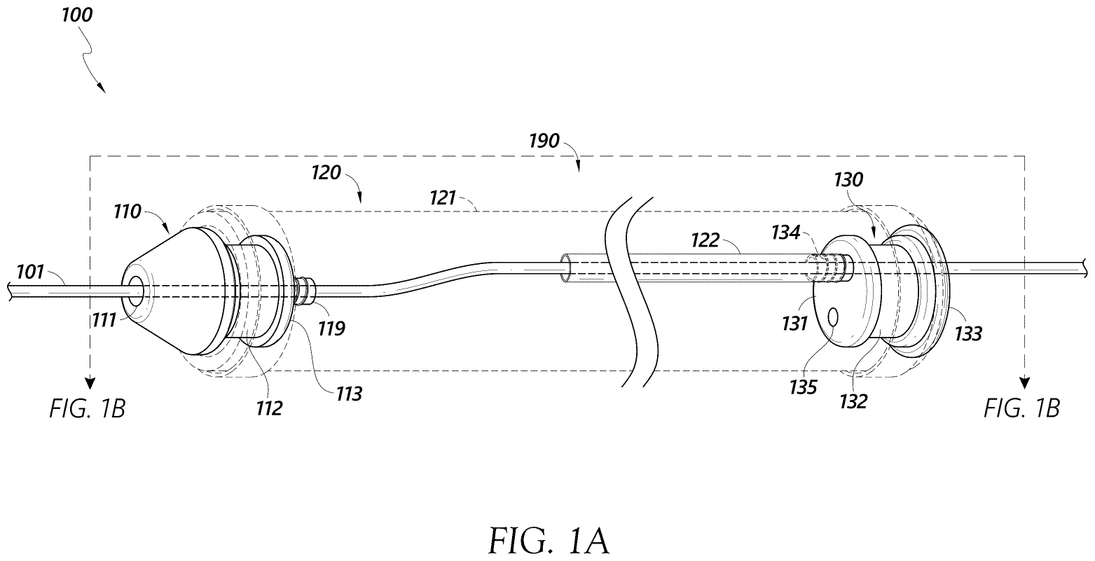

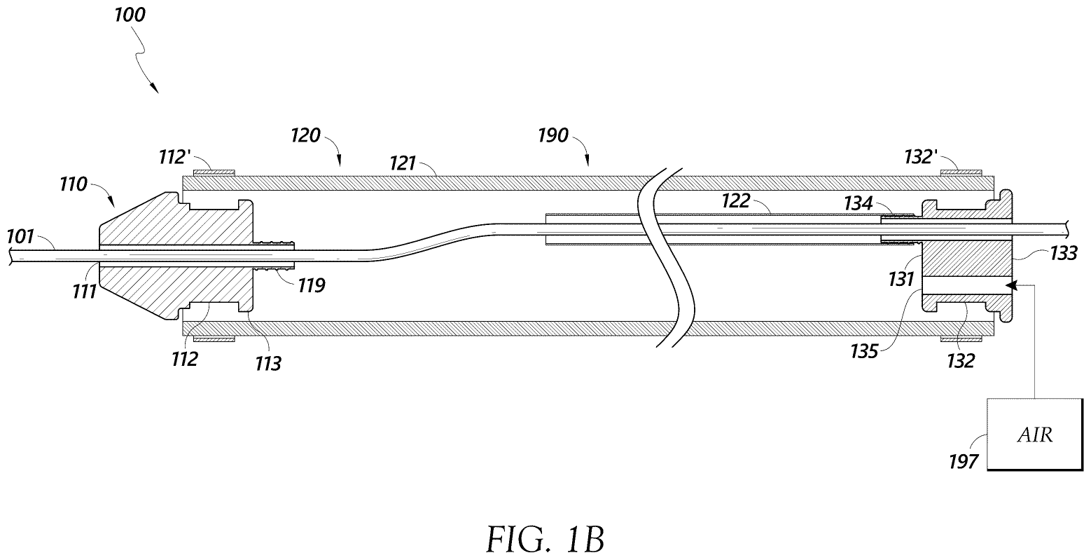

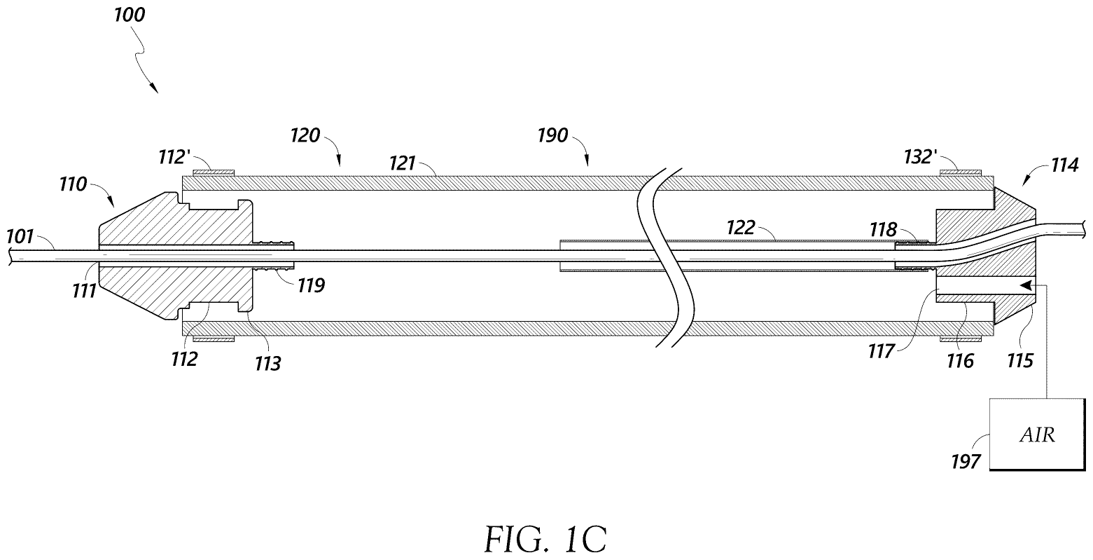

### FIG. 1—Structural Features of Certain Improved Embodiments

The present specification discloses various improved structural features that are described below. It should be noted that no single feature is considered essential or indispensable, and different features may be employed alone or in combination with one another. Furthermore, specific proprietary members, such as proprietary heads, proprietary body members, proprietary guidance rod tips, and proprietary closing members, may be utilized in conjunction with one another or in combination with other elements, including other heads, body members, or closing members, in various configurations.

### Flexible Guide Rod

With reference to FIGS. 1A-C, some aspects of the present disclosure relate to the use of a pipe repair system 100 configured to interface with a flexible guide rod 101 system to help navigate to the precise location of the subsurface failure.

In various embodiments, the flexible guide rod is configured to be able to be shaped and oriented prior to insertion. In other embodiments a shaped guidance tip may be attached to the leading edge of flexible push rod. The guide rod substantially retains the shape imparted to it as it is navigated through an environment such as a pipe system. The shape or attachment imparted onto the guide rod can be used to navigate obstacles that existing techniques and methods are not capable of navigating.

In particular, it has been found that a shaped flexible guide rod or leading edge attachment is particularly useful to navigate obstacles such as vertical or horizontal offset breaks where the flexible guide rod needs to travel upwards against the force of gravity to travel from one section of lower pipe to a second section of higher pipe, such as in the event of a vertical offset break between a first and second section of pipe. The flexible guidance rod with it's a bend at the tip, shape or attached shaped attachment can be easily twisted and manipulated to pass through many obstacles or defects that stop conventional equipment that is currently available. This process is usually completed with the assistance of a sewer scope or camera. These obstacles or obstructions include but are not limited to missing pipe, brakes in pipe including brakes at bends, misaligned or offset pipe, gaps at pipe joints, and lateral pipe connections, among the like.

Various different materials may be used to prepare a suitable guide rod 101 for a guide system. In various different implementations, the guide rod 101 may be prepared from, or exhibit properties similar to, rigid or semi-rigid rod, pole, wire or other specimens such as: fiberglass rod, metal rod, gooseneck cables and semi-rigid coaxial cables along with any form of any flexible material including but not limited to wound spring type cable, flexible steel or other flexible material. All of these exemplary materials exhibit desirable properties that benefit the use of a guide rod system. Namely, resilient and rigid properties allowing the guide rod to be bent, kinked, twisted, shaped or otherwise formed in a manner suitable to navigate the determined subsurface features. The flexible guide rod tip may be configured to substantially retain a shape imparted to it to facilitate guiding the wire past the location of the fault, and to facilitate navigating the repair system to the fault using the guide rod.

### Proprietary Heads

In various configurations embodiments of the presently disclosed systems may include proprietary heads 110, as shown in FIGS. 1A-C.

The proprietary heads 110 may be configured to navigate obstacles. For instance, the proprietary head may be configured with a generally conical or frustoconical shape that extends from the front of the repair tool. It will be appreciated that a large number of different proprietary heads may be attached to the repair tool to help the tool navigate obstacles. These proprietary heads may be arranged in a variety of shapes such as substantially spherical, substantially frustoconical, substantially conical, pointed, blunted, or angled as useful to navigate the obstacles within the system.

The proprietary head 110 may be prepared from a material that is softer than the surrounding pipes, such as a plastic that technician can grind away in the event the head becomes stuck or lodged without damaging the tougher surroundings such as a metallic, clay, or concrete pipe. In other embodiments, the proprietary head may be prepared from a more durable material such as a metal material or an alloy.

In various embodiments the proprietary head 110 is configured to retract below or within a proprietary body member 120 to which it may be affixed. Namely, in various configurations, the proprietary head member 110 can be permanently attached or removably affixed to a body member such as a proprietary body member 120. The proprietary head may include an opening 111 configured to receive a guide rod. As shown in FIGS. 1A-C, the guide rod opening 111 is configured to extend through the proprietary head 110 to allow the guide rod 101 to traverse through the proprietary head 110.

The proprietary head may include a clamp or permanently adhered section 112 and a retaining section 113. In various embodiments, one or more of the clamp section or permanently adhered section 112 and retaining section 113 are configured to be housed within a proprietary body member 120 to facilitate a removable coupling between the proprietary head 110 and a body member 120, such as the outer body member 121 overlapping the clamp section 112 and retaining section 113 of the proprietary head 110. In various configurations a clamp 112′ can be used to secure the body member 120 around the head member 110 over the clamp section 112 as shown in FIG. 1B.

Various proprietary heads may be configured to interface with a flexible guide rod system without compromising the existing functionality of the overall repair system due to the modifications made to the proprietary head and repair system discussed herein.

For instance, in various configurations, certain proprietary heads 110 can be configured to accept a feed of guide rod 101 and route the guide rod through a proprietary body member 120 to exit the repair tool 190. The proprietary head 110 also blocks air flow from passing out of the air chamber through the head end of the proprietary body member.

As shown in FIGS. 1A-C, the proprietary head 110 includes threaded interface 119. In some particularly advantageous embodiments, the threaded interface 119 further includes a flexible guide rod channel configured to accept the guide rod 101 and route it to the interior of the device without compromising the integrity or function of the overall repair tool as discussed below.

In various embodiments the proprietary head members may be prepared from a variety of materials. In some suitable implementations it has been found that various plastics and metals are suitable for use in the preparation of a head member and provide various advantages. For example, it has been found that plastic head members can easily be removed with robotic grinder or miller and cut away if the device becomes snagged on an obstacle during a repair. Furthermore, if the device becomes stuck or lodged in any way, drilling or cutting the plastic head is less likely to result in inadvertent damage to the surrounding pipe system, especially where the pipe system is a non metallic pipe system.

### Proprietary Body Members

As another example, in various configurations embodiments of the presently disclosed systems may include proprietary body members 120.

The one or more proprietary body members 120 may be configured to interface with one or more of a flexible guide rod 101 system and an air supply system 197. In various configurations the one or more proprietary body members 120 may include one or more body members configured to be communicable coupled with an air supply 197 in order to receive air therefrom, as shown in FIG. 1B. In some configurations the one or more proprietary body members 120 may include one or more body members configured to interface with a flexible guide rod 101 system.

In some particularly advantageous configurations, the presently disclosed systems and methods utilize modified and improved repair tool designs to achieve the desired functionality. For instance, in some configurations, the proprietary body member 120 may include an outer body member 121 configured to overlap the proprietary head 110, leaving a portion of the frustoconical shape extending therefrom. Internal to the proprietary body member 120 may be disposed a flexible guide rod channel 122 configured to receive a flexible guide rod and to channel the flexible guide rod through the device without interfering with the function of the device, such as by interfering with the requisite airflow used to inflate the repair tool.

In some particularly advantageous configurations, the present systems and methods utilize a proprietary head 110 coupled with a proprietary body member 120 configured to be communicably coupled with an air supply 197 allowing the proprietary body 120 member to be filled with air therefrom.

Likewise, as discussed above, in various configurations the present systems and methods may utilize a proprietary head 110 coupled with proprietary body member 120, the proprietary body member housing an internal flexible guide rod channel 122 communicably coupled with the threaded interface 118 of the closing member 114 and further with the flexible guide rod opening 111 of the proprietary head 110. In this manner, the device can be configured to receive a flexible guide rod 101 through the proprietary head 110 and route the flexible guide rod through the repair tool without compromising the flow of air or other internal functions of the device, as further explained below.

### Exit Interface Member

In various configurations, the presently disclosed systems and methods may utilize a proprietary exit interface member 130 affixed to the rear of the body member 120 opposite the proprietary head 110.

Specifically, the proprietary exit interface member 130 can be configured to partially reside within the body member 120 and partially external thereto, in a similar manner to the proprietary head 110. In some specific implementations, the proprietary exit interface member 130 may include an internal portion 131. The internal portion 131 may be configured to be disposed within the body member 120. Likewise, the exit interface member 130 may include as clamp section 132 configured to be surrounded by the body member 120 and clamped thereto via clamp 132′, in a similar manner to the clamp section 112 of the proprietary head 110.

The exit interface member 130 may further comprise a rear plate 133 configured to extend past the body member 120 and to provide an exit path for the flexible guide rod 101 to travel through threaded interface 134 of exit interface member 130 and to travel out the rear of the device. The threaded interface 134 can be configured to be removably coupled with the flexible guide rod channel 122 to more effectively route the flexible guide rod 101 through the closing member 130 and out the rear of the device.

In various configurations, the rear plate 133 of the exit interface member 130 can be configured to create an airtight seal within the body member 120. For instance, as best shown in FIG. 1B, the proprietary exit interface member 130 may include an air channel 135 configured to be communicably coupled with an external air supply 197 to provide for the ingress of air into the internal space of the body member 120. In this manner, the internal space of the body member 120 can be filled with air, such that the body member expands, for instance, to apply a patch to an inner surface of a ruptured pipe.

In some configurations, such as that shown in FIG. 1C, the proprietary head may be coupled with an exit interface member 114. The exit interface member 114 may include a substantially frustoconical portion 115 and a substantially cylindrical portion 116. Disposed along the substantially cylindrical portion 116 of the closing member 114 may be an interface, such as threaded interface 118 configured to allow the closing member to be removably coupled to the flexible guide rod channel 122. Also housed within the exit interface member 114 may be a communication interface such as a pathway 117 bored into the substantially cylindrical portion 116 of the closing member 114. In various embodiments, the communication pathway 117 may be used to communicably couple an air interface with the interior of the repair tool 190.

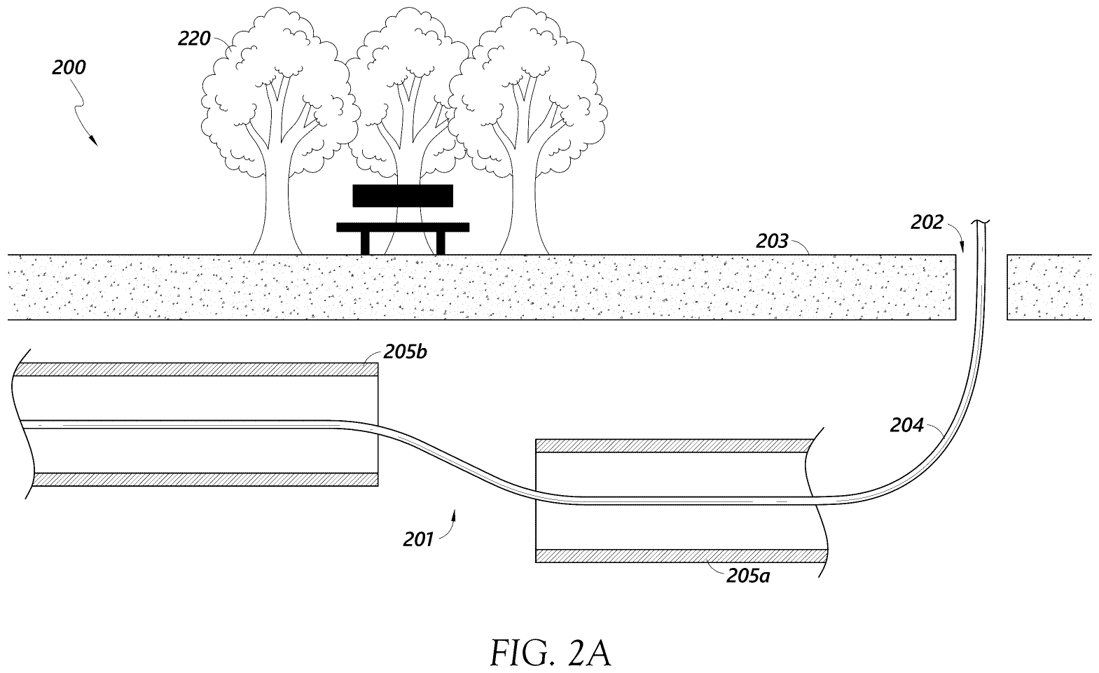

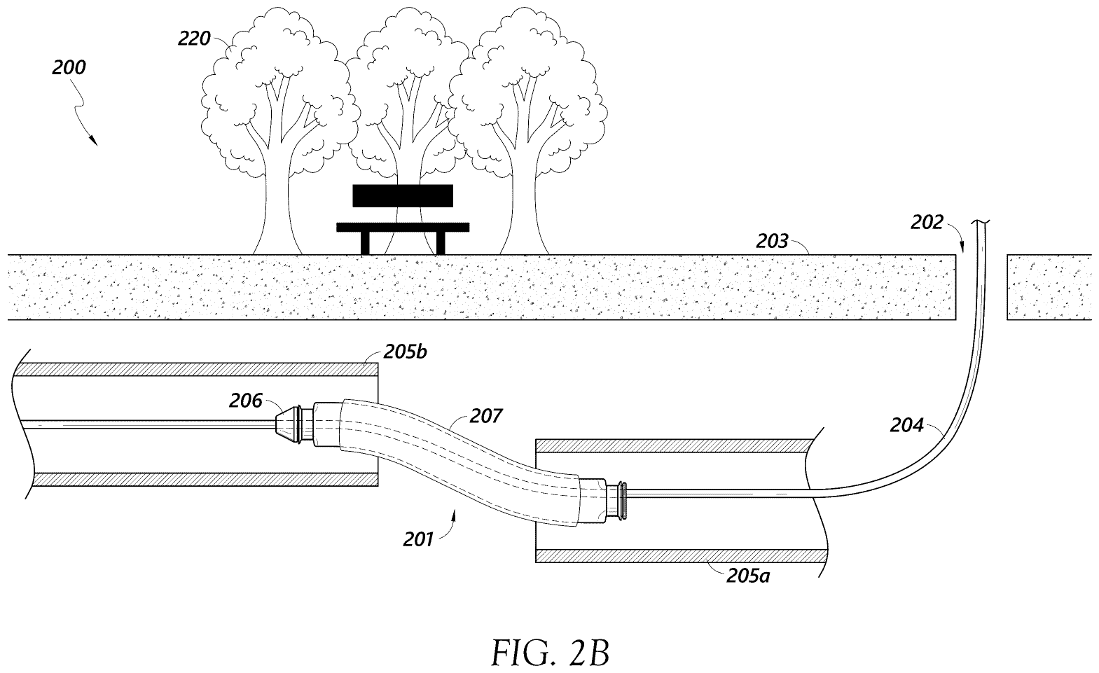

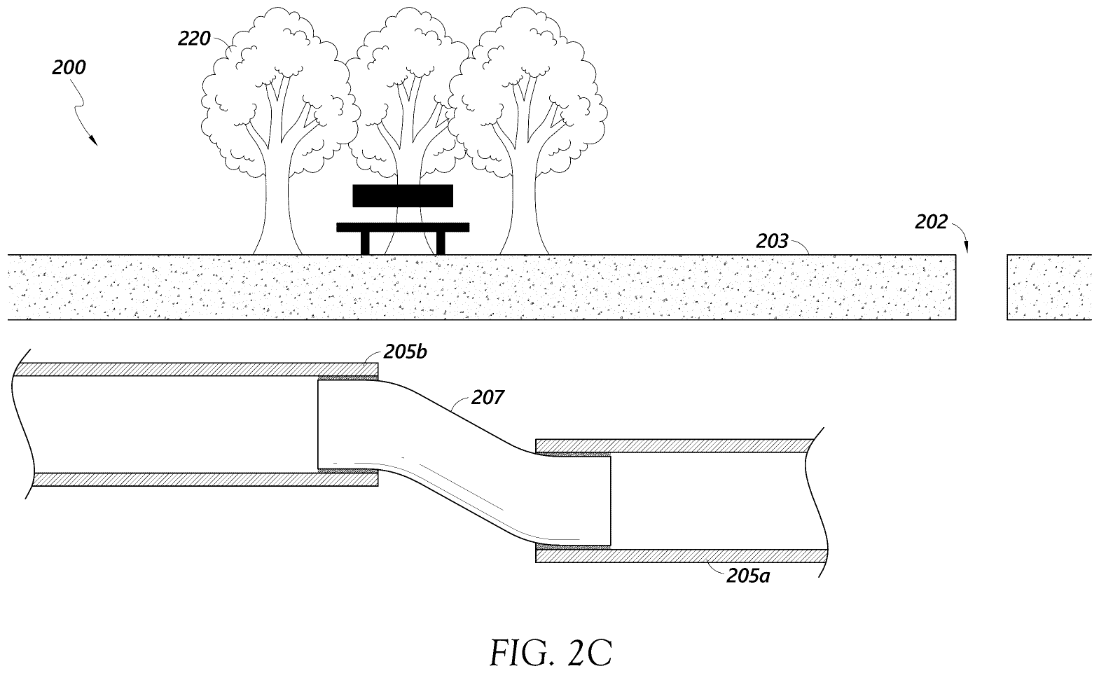

### FIG. 2—Certain Methods of Subsurface Fault Remediation

Various examples of processes for repairing a subsurface fault are described below. In some implementations, the subsurface fault may include a complex subsurface fault, and the remediation may be performed through a single excavation point. While the general process is provided below, modifications can be made by those skilled in the art and the steps can be performed in alternative orders. Additionally, intervening steps may be performed between the outlined steps, and the present disclosure is not limited to any one example provided herein.

As shown in FIG. 2A, in some implementations, the process 200 may begin when a subsurface failure 201 is detected. Optionally, investigation may be performed into the nature of the subsurface failure 201. In some configurations, the investigation may comprise excavating a single hole 202. Through the single excavated hole 202 an investigation may be conducted. For example, in some configurations a remote viewing device such as a camera may be inserted into the excavated hole to determine the nature and location of the subsurface failure (not depicted).

Determining the nature of the subsurface failure 201 may include identifying the location and type of the subsurface failure. For example, in some implementations it may be determined that a subsurface failure 201 has been identified beneath the ground 203 at a certain determined position. An example of a subsurface failure 201 that is notoriously difficult to repair is a vertical offset break where the sections of pipe 205a, 205b have broken away from one another such that a repair tool must navigate upwards against the force of gravity to traverse the breakage. These types of failure are notoriously difficult to repair because existing techniques struggle to accurately navigate the bends in complex pipe systems. For instance, push packers struggle to navigate complex bends, joints, junctions, and offset breaks due to their limited directional mobility due to their singular push style control mechanism which lacks directional finesse. Likewise, push-pull packs would require multiple excavation sites which can damage landscaping or require excavating sites which can require additional permitting and greatly increase the cost of the repair, especially where the multiple excavation sites may not be located on a singular lot. Conversely, the presently disclosed systems and methods may utilize the flexible guide rod system to navigate kinks, bends, and joints in complex pipe systems and navigate to the location of the break. In various configurations, the presently disclosed systems and methods can be used to establish a flexible guide rod path up against the force of gravity to traverse a vertically offset break to allow proper positioning of the repair tool.

Once the nature of the subsurface failure 201 is determined, a flexible guide rod 204 may be prepared for insertion. Preparing a guidewire 204 for insertion may include making modifications to the flexible guide rod based on the determined nature and location of the fault, such as the type of fault and route of piping required to travel to the failure site, which may be around bends, through junctions, and traversing offset breaks.

In some configurations it may be determined that the subsurface failure 201 is a vertical offset break that has occurred in the system. For instance, a vertical offset break may be located past a bend in a pipe. As such, in some configurations the flexible guide rod 204 may be prepared for insertion by bending or kinking the wire in a suitable fashion to maneuver the flexible guide rod to the location of the subsurface failure 201, and in some implementations, past the location of the break. Advantageously the wire can be configured to retain the shape imparted upon it prior to insertion into the excavation site to facilitate the process of manipulating the flexible guide rod into a correct position. For example, in the event of a vertical offset break occurring past a bend in a pipe, the tip of the flexible guide rod may be bent at an arbitrary angle determined to be suitable to navigate the vertical offset break. Likewise, a bend may be imparted further down the flexible guide rod to facilitate the process of navigating the flexible guide rod past the bend in the pipe.

After the flexible guide rod 204 is prepared for insertion, the flexible guide rod is navigated to the location of the subsurface failure 201 as depicted in FIG. 2A. In various embodiments, the shape imparted upon the flexible guide rod prior to insertion is used to guide the wire to a desired location. For example, the wire may be bent upwards to allow the flexible guide rod to navigate a vertical offset break against the force of gravity.

In various implementations the flexible guide rod 204 and associated system is configured to accommodate a camera, and in some embodiments, may allow for the passage of a camera cable in conjunction with flexible guide rod and associated repair system.

In some implementations the flexible guide rod 204 may be navigated past the location of the subsurface failure 201 to facilitate repair. Likewise, in various configurations the flexible guide rod 204 may be anchored in place to prevent inadvertently jostling the wire away from the desired location throughout the rest of the process.

As shown in FIG. 2B, remediation steps may be performed once the flexible guide rod 204 has been inserted into the desired location, and optionally that the location has been confirmed through the use of a sensing apparatus such as a remote camera. Advantageously, in various configurations the remediation steps may be performed through the access provided by the single excavated hole 202. In some implementations, the remediation steps may include the placement of a patch 207 or other remediation mechanism at the location of the subsurface failure 201.

For example, in some configurations the present disclosure relates to a guidable packer system 206. In some configurations a guidable packer system 206 can be coupled with the flexible guide rod 204 in order to guide the guidable packer system 206 to the location of the break 201 in order to apply a patch 207. Advantageously, the presently disclosed systems and methods allow for the guidable packer system 206 to be guided to the proper location, even around bends and even up against the force of gravity to repair vertical offset breaks. Once in place, the guidance system is narrow enough that the guidable packer system 206 and a sensing apparatus such as a remote cable camera can detect the progress of the remediation. In some implementations, air can be supplied to the guidable packer system 206 in place to expand the packer and allow for the placement of a patch 207 across the vertical offset break, thereby connecting the portions of pipe and remediating the subsurface failure.

As shown in FIG. 2C, once the patch 207 has been expanded and put in place, the guidable packer system 206 and flexible guide rod 204 can be withdrawn through the single excavated hole 202. In this manner, a subsurface fault 201 such as a vertical offset break can be repaired through a minimally invasive single access point 202 without damaging the remainder of the ground 203 or landscaping 220 or other valuable features that may reside thereon such as roads, pathways, and the like and without requiring additional permitting for excavating another site on adjacent property.

It will be appreciated that a variety of mechanisms exist for pushing the repair tool into place. For instance, in some configurations a push rod configuration may be utilized where a rod or other rigid or semi rigid member is utilized to press the tool into position. In other configurations, a flexible member may be used to press the tool into position. In still further embodiments, in some configurations, a drive mechanism may be utilized to press the tool into position. It will be appreciated that any of the foregoing mechanisms may be utilized in a manual manner or automatic manner making use of hydraulic, pneumatic, or similar mechanisms for automatic operation.

### Certain Advantages of the Presently Disclosed Systems, Techniques, and Methods

In some embodiments, the present disclosure relates to systems and methods allowing for the repair of subsurface failure with minimal excavation, such as utilizing only a single excavation site or digging only a single hole.

In various configurations, the presently disclosed systems, techniques, and devices can be utilized to excavate a single access point, to investigate the nature of the subsurface failure, and to perform remediation measures through the single access point. The presently disclosed systems, techniques, and methods allow for more accurate repairs, such as more accurate placement of patches configured to remedy subsurface faults. Furthermore, the presently disclosed systems, techniques, and devices enable a user to navigate a flexible guide rod to the location of a subsurface failure, even around bends, kinks or offset breaks and up against the force of gravity.

In various implementations, a substantially rigid flexible guide rod system may be utilized to navigate to a subsurface failure site in need of repair. The substantially rigid flexible guide rod may be shaped or otherwise formed prior to insertion into the single excavation site. The shape or form imparted to the flexible guide rod may help the flexible guide rod traverse various obstacles commonly encountered.

As disclosed herein, the systems, techniques, methods, and devices can be used together and integrated amongst one another to yield improved systems, techniques and devices that allow for the repair of more complex subsurface faults than was previously possible, especially when performed through only a single access point.

### Certain Terminology

As discussed above, various features of the above embodiments described can be combined in different combinations to meet different goals for functionality and design. Although the above embodiments have been discussed in the context of subsurface fault repair system, it will be appreciated that the presently disclosed subject matter is applicable to the remediation of various types of breakages that can occur within a sewage system, such as a cracked pipe, ruptured pipe, broken pipe, and the like. In various implementations the presently disclosed systems and methods may be particularly advantages for the repair of complex subsurface faults such as vertically offset breaks requiring a repair tool to operate against the force of gravity or traverse a network comprising bends, kinks, joints, or other obstacles.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

As used herein, a rubber material can be broadly defined as a flexible, elastic substance made from either natural rubber, derived from the latex of rubber trees, or synthetic polymers created through chemical processes.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. The term “generally” as used herein represents a value, amount, or characteristic that predominantly includes, or tends toward, a particular value, amount, or characteristic. As an example, in certain embodiments, as the context may dictate, the term “generally parallel” can refer to something that departs from exactly parallel by less than or equal to 20 degrees and/or the term “generally perpendicular” can refer to something that departs from exactly perpendicular by less than or equal to 20 degrees.

Overall, the language of the claims is to be interpreted broadly based on the language employed in the claims. The claims are not to be limited to the non-exclusive embodiments and examples that are illustrated and described in this disclosure, or that are discussed during the prosecution of the application.

What is claimed is:

1. A system for pipe repair comprising:
a head member configured to be partially housed within an expandable body member;
a retaining member configured to be partially housed within the expandable body member opposite the head member; and
a flexible guide rod channel disposed within the body member.

2. The system of claim 1, wherein the head member comprises a flexible guide rod interface including an opening disposed on a portion of the head member external to the expandable body member.

3. The system of claim 2, wherein the opening extends through the head member to provide access for a flexible guide rod to the interior of the body member.

4. The system of claim 1, wherein the head member includes a retaining section and a clamp section.

5. The system of claim 4, wherein the diameter of the clamp section is less than the diameter of the retaining section.

6. The system of claim 1, wherein the head member is configured to be removably coupled to a closing portion housed within the expandable body member.

7. The system of claim 6, wherein the closing portion has a substantially cylindrical portion and a substantially frustoconical portion.

8. The system of claim 7, wherein the closing portion has a threaded interface disposed on the substantially cylindrical portion for coupling to the head member.

9. The system of claim 8, wherein the threaded interface of the closing member includes a flexible guide rod access channel traversing through the closing portion.

10. The system of claim 1, wherein the retaining member has a first channel configured to receive a flow of air directed to an internal portion of the expandable body member.

11. The system of claim 1, wherein:
the flexible guide rod channel is communicably coupled with the head member through the flexible guide rod interface disposed through the head member;
the flexible guide rod channel is communicably coupled with the closing member through the head member through a threaded flexible guide rod interface disposed on the closing member;
the flexible guide rod channel is communicably coupled with a retaining member through a threaded interface disposed on a portion of the retaining member housed within the expandable body member; and
the flexible guide rod channel provides an exit point to exit the device through the rear of the retaining member.

12. A head for a pipe packer repair tool configured to interface with a flexible guide rod system:
the head having a first portion configured to extend from the front of a pipe repair system and a second portion configured to interface with the interior of a pipe repair system;
the head having an access point for a flexible guide rod to be routed into the interior of a pipe packer repair tool;
the access point on the head being communicably coupled with an internal channel disposed through the head and configured to receive a flexible guide rod;
the internal channel within the head being configured to be removably coupled with a closing portion;
the closing portion having a substantially cylindrical portion and a substantially frustoconical portion;
the closing portion having an interface configured to be removably coupled to the internal channel within the head;
the interface of the closing portion being communicably coupled with an internal channel disposed through the closing portion and configured to receive a flexible guide rod;
the internal channel of the closing portion in communication with a flexible guide rod channel disposed within the pipe packer repair tool configured to receive a flexible guide rod;
the flexible guide rod channel configured to be removably coupled to an exit interface member through an interface and to extend from the rear of the pipe packer repair tool.

13. The device of claim 12, wherein the portion of the head configured to extend from the front of a pipe repair system has a substantially frustoconical shape.

14. The device of claim 12, wherein the access point is disposed at the leading edge of the frustrum.

15. The device of claim 12, wherein the head is made from a rubber material.

16. The device of claim 12, wherein the internal channel within the head is configured to be removably coupled through a threaded interface of a closing portion.

17. The device of claim 16, wherein the threaded interface is disposed on the substantially cylindrical portion positioned adjacent to the head member.

18. The device of claim 17, wherein the interface is a threaded interface comprising a threaded extension disposed on the closing member configured to interface with a threaded receiving member disposed on the second portion of the head member.

19. A method for repairing a complex subsurface fault through a single excavation site, the method comprising the steps of:
excavating a single access point;
determining the location and nature of the subsurface fault through the single access point;
manipulating a substantially rigid flexible guide rod for insertion into the single access point, wherein the manipulations are based on the determined location and nature of the subsurface fault;
inserting the flexible guide rod through the single access point and navigating to the location of the subsurface fault;
threading a pipe packer repair tool onto the flexible guide rod and navigating the repair tool to the location of the subsurface fault;
applying a patch at the location of the subsurface fault; and
removing the pipe packer repair tool and flexible guide rod from the single excavation point.

20. The method of claim 19, wherein determining the nature of the subsurface fault comprises determining the fault is a vertically offset break in a pipe;
wherein the manipulations include bending the wire to navigate against the force of gravity to traverse an offset break; and
wherein navigating the repair tool to the location of the subsurface fault comprises pushing the pipe packer repair tool forward along the flexible guide rod such that the pipe packer repair tool traverses the vertically offset break up against the force of gravity.
